(19) United States
(12) Patent Application Publication
(10) Pub. No.: US 2009/0284855 A1
(43) Pub. Date: Nov. 19, 2009

(54) LENS BARREL DRIVER

(76) Inventors: Hiroshi KATO, Saitama-shi (JP); Yoshitaka Mori, Saitama-shi (JP)

Correspondence Address: BIRCH STEWART KOLASCH & BIRCH, PO BOX 747, FALLS CHURCH, VA, 22040-0747, US

(21) Appl. No.: 12/434,968

(22) Filed: May 4, 2009

(30) Foreign Application Priority Data
May 13, 2008 (JP) P2008-126273

(51) Int. Cl. G02B 7/04

(52) U.S. Cl. 359/824

(57) ABSTRACT

A switching gear 64 is provided that activates and deactivates the coupling between a zoom ring 18 rotatably disposed on a lens barrel 14 and a motor 50. The switching gear 64 moves to a motor driving position to activate the coupling between the zoom ring 18 and the motor 50 and a manual driving position to deactivate the coupling between the zoom ring 18 and the motor 50 by a drive pin 74 moved by an operation switching knob 42. When the switching gear 64 moves to the manual driving position, the switching gear 64 is coupled only to the zoom ring 18 and is pressed against the drive pin 74 by a spring 80, and a frictional resistance is applied between the switching gear 64 and the drive pin 74 by a friction member 82. Consequently, a load is applied against the rotation of the zoom ring 18 at the time of manual driving.

### CROSS-REFERENCE TO RELATED APPLICATIONS

This application is based on and claims priority under 35 USC 119 from Japanese Patent Application No. 2008-126273 filed May 13, 2008; the entire contents of which are incorporated herein by reference.

### BACKGROUND

1. Technical Field

The present invention relates to a lens barrel driver, and more particularly, to a lens barrel driver capable of switching between manual driving and electrically powered driving of a lens operation ring rotatably provided on the lens barrel.

2. Related Art

Among lens barrels used for television cameras for broadcasting or business uses, consumer video cameras and the like, lens barrels are known that have on the periphery thereof an operation ring for focusing (focus lens) and zooming (zoom lens) and are provided with a driver (drive unit) capable of rotating the operation ring while switching between manual operation (manual driving) and electrically powered operation (servo driving) (for example, see Patent Reference 1 (Japanese Patent No. 2773230) and Patent Reference 2 (Japanese Unexamined Patent Application Publication No. 2000-249895 corresponding to U.S. Pat. No. 6,456,796)).

According to these Patent References 1 and 2, a clutch mechanism is provided between a gear formed on the periphery of the operation ring and a gear attached to the output shaft of the motor. When this clutch mechanism is set in the servo driving state, the gear of the operation ring and the gear of the motor are coupled together, so that a state is set in which the power of the motor is transmitted to the operation ring. On the other hand, when the clutch mechanism is set in the manual driving state, when the operation ring is manually driven, the gear of the operation ring and the gear of the motor are uncoupled from each other, so that a state is set in which the operation ring can be directly driven by hand without any load on the motor.

However, in the driver as described above, when the state in which the operation ring is manually driven is set, if the lens barrel is tilted upward or downward with the operation ring untouched by a hand, since there is no load on the motor, the lens is moved by the self weight of the lens or the movement frame that moves as the operation ring is rotated.

If a load is simply applied against the rotation of the operation ring to solve this problem, the load is additionally required also when the operation ring is electrically driven, which increases power consumption and can result in faulty operation.

### SUMMARY

The present invention is made in view of such circumstances, and an object thereof is to provide a lens barrel driver that appropriately prevents the problem in that a load is applied against the rotation of the operation ring at the time of manual driving and the lens (aperture diaphragm, etc.) is unintentionally moved by a tilt of the lens barrel or the like.

[1] According to an aspect of the invention, a lens barrel driver includes an operation ring that is rotatably provided on a lens barrel; a motor that drives the operation ring; a power transmitting member that is rotatably supported by a stationary shaft, the power transmitting member being disposed so as to be movable between a position of a motor driving state and a position of a manual driving state; a state switching member engaged with the power transmitting member, the state switching member moving the power transmitting member between the position of the motor driving state and the position of the manual driving state; and a resistance applying unit that applies a resistance against a rotation of the power transmitting member at an abutting portion between the power transmitting member and the state switching member when the power transmitting member is set at the position of the manual driving state, the resistance applying unit applying a resistance against a rotation of the operation ring when the power transmitting member is set at the position of the manual driving state. The power transmitting member is coupled to both the operation ring and the motor when being at the position of the motor driving state. The power transmitting member transmits a power of the motor to the operation ring when being at the position of the motor driving state. The power transmitting member is coupled to the operation ring and is separated from the motor at the position of the manual driving state. The power transmitting member does not transmit the power of the motor to the operation ring at the position of the manual driving state.

According to [1], since the rotation of the operation ring causes a resistance, that is, a load is caused in the manual driving state where the coupling between the operation ring and the motor is deactivated, unintentional moving of the lens by a tilt of the lens barrel or the like is prevented.

[2] According to the lens barrel driver of [1], the resistance applying unit includes a spring that presses the power transmitting member against the state switching member when the power transmitting member is set at the position of the manual driving state. A length of the spring, when the power transmitting member is set at the position of the motor driving state, is substantially a natural length. The spring, when the power transmitting member is set at the position of the manual driving state, is extended or compressed so as to be longer or smaller than the natural length.

The lens barrel driver of [2] shows an embodiment for applying a load (resistance) against the rotation of the operation ring in the manual driving state, and the frictional resistance is increased with increasing the pressure between the power transmitting member and the state switching member by the pushing force of the spring.

[3] According to the lens barrel driver of [1] or [2], the resistance applying unit includes a friction member that is provided to cause a frictional resistance against the rotation of the power transmitting member at the abutting portion between the power transmitting member and the state switching member when the power transmitting member is set at the position of the manual driving state.

The lens barrel driver of [3] shows an embodiment for applying a load (resistance) against the rotation of the operation ring in the manual driving state, and the frictional resistance is increased by disposing the friction member at the abutting portion between the power transmitting member and the state switching member.

According to [1], [2] or [3], applying a load against the rotation of the operation ring at the time of manual driving appropriately prevents the lens or the like from unintentionally moving by a tilt of the lens barrel or the like. Moreover, applying a moderate load against the operation of the operation ring in a manual driving improves operability.

### BRIEF DESCRIPTION OF THE DRAWINGS

FIG. 1 is a side view showing the exterior of a lens barrel used for television cameras for broadcasting or business uses, consumer video cameras and the like.

FIG. 2 is a relevant part enlarged view showing the structure of a zoom drive mechanism, and shows the state in which a zoom ring is servo-driven.

FIG. 3 is a relevant part enlarged view showing the structure of the zoom drive mechanism, and shows the state in which the zoom ring is manually driven.

FIG. 4 is a view illustrating the selection positions of an operation switching knob for switching the operation of the zoom ring (zoom operation) between servo driving and manual driving.

### DETAILED DESCRIPTION

Hereinafter, an exemplary embodiment for carrying out the lens barrel driver according to the present invention will be described in detail with reference to the drawings.

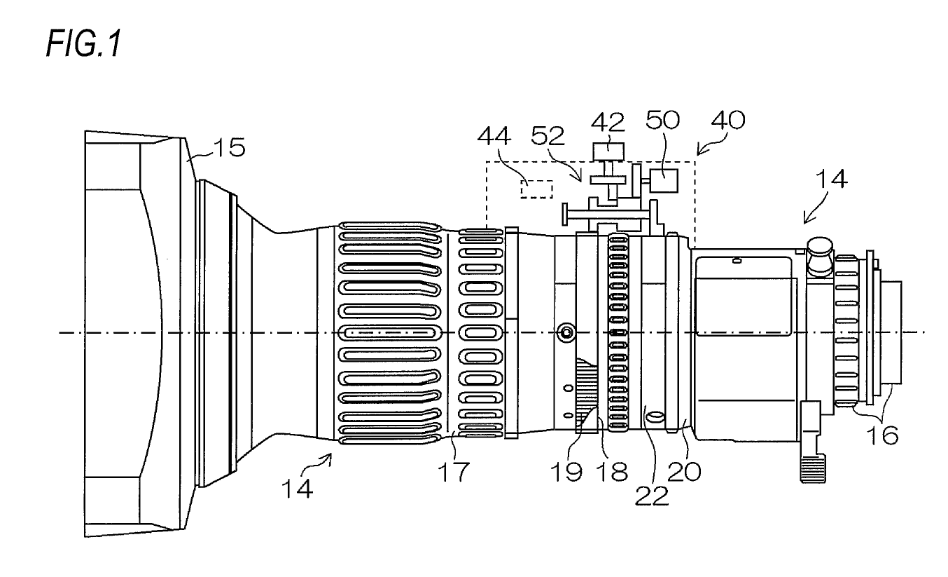

FIG. 1 is a side view showing the exterior of a lens barrel used for television cameras for broadcasting or business uses, consumer video cameras and the like. A lens barrel 14 in the figure has a hood 15 attached to its front end. And the lens barrel 14 has at its rear end a mount 16 for the attachment to a camera body. Here, the present invention is also applicable to a lens barrel integrated with a camera body. In that case, the mount 16 makes the lens barrel detachably attachable to the camera body is not provided.

On the periphery of the lens barrel 14, a focus ring 17, a zoom ring 18 and an iris ring 20 are provided as rotatable operation rings. In the lens barrel 14, elements (not shown) of a taking optical system for forming a subject image is disposed, a focus lens for focus adjustment and a zoom lens (variable lens) for zoom adjustment (focal length adjustment) are disposed so as to be movable in the direction of the optical axis, and an aperture diaphragm for light quantity adjustment is disposed so as to be openable and closable.

The focus lens, the zoom lens and the aperture diaphragm are coupled to the focus ring 17, the zoom ring 18 and the iris ring 20, respectively. Consequently, rotating the focus ring 17 rotates the focus lens, moving the zoom ring 18 moves the zoom lens, and moving the iris ring 20 opens or closes the aperture diaphragm.

A driver 40 for electrically rotating all or some of the focus ring 17, the zoom ring 18 and the iris ring 20 is attached to a side surface of the lens barrel 14. In the figure, a zoom drive mechanism for electrically driving the zoom ring 18 is shown. In the zoom drive mechanism, a motor 50 is coupled to the zoom ring 18 through a clutch mechanism 52 as described later in detail.

The clutch mechanism 52 activates and deactivates the coupling (connection) between the motor 50 and the zoom ring 18. When the clutch mechanism 52 activates the coupling between the motor 50 and the zoom ring 18, the power of the motor 50 is transmitted to the zoom ring 18, so that the zoom ring 18 can be driven by the motor 50 (servo driving).

When the clutch mechanism 52 deactivates the coupling between the motor 50 and the zoom ring 18, the coupling between the motor 50 and the zoom ring 18 is cut off, so that the zoom ring 18 can be manually driven by a hand grasping the zoom ring 18 without any load on the motor 50.

The driver 40 has on its casing an operation switching knob 42 for the user to select the operation of the zoom ring 18 (zoom lens), that is, whether to perform the zoom operation by servo driving (motor driving) or by manual driving. Although details will be described later, the state of the clutch mechanism 52 can be switched in conjunction with the operation switching knob 42.

When the user sets the operation switching knob 42 at the position to select servo driving in the case where the zoom operation is performed by servo driving, the clutch mechanism 52 is set in the state of activating the coupling between the motor 50 and the zoom ring 18, so that the zoom ring 18 can be driven by the motor 50. The driver 40 has on its casing a zoom seesaw switch 44 operated by the user when the zoom operation is performed by servo driving. Although details are not described, the motor 50 is servo-controlled according to the operation of the zoom seesaw switch 44. Therefore, by setting the operation switching knob 42 at the position to select servo driving and operating the zoom seesaw switch 44 toward the wide-angle side or the telephoto side, the user can drive the zoom ring 18 by the motor 50 to electrically move the zoom (zoom lens) of the taking optical system toward the wide-angle side or the telephoto side.

On the other hand, when the user sets the operation switching knob 42 at the position to select manual driving in the case where the zoom operation is performed by manual driving, the clutch mechanism 52 is set in the state of deactivating the coupling between the motor 50 and the zoom ring 18. Therefore, the user can rotates the zoom ring 18 by the manual force of the hand grasping the zoom ring 18 without any load on the motor 50, and can manually move the zoom of the taking optical system toward the wide-angle side or the telephoto side.

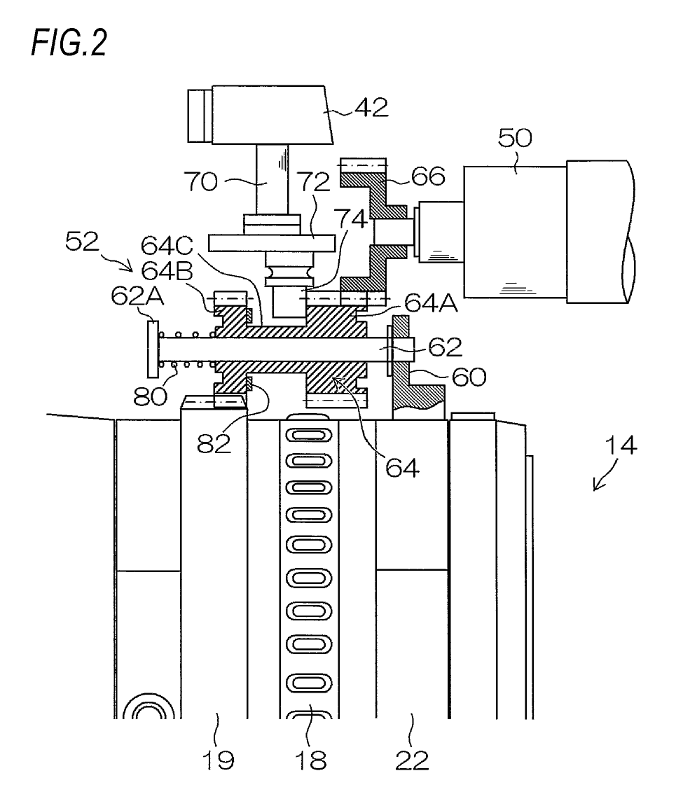

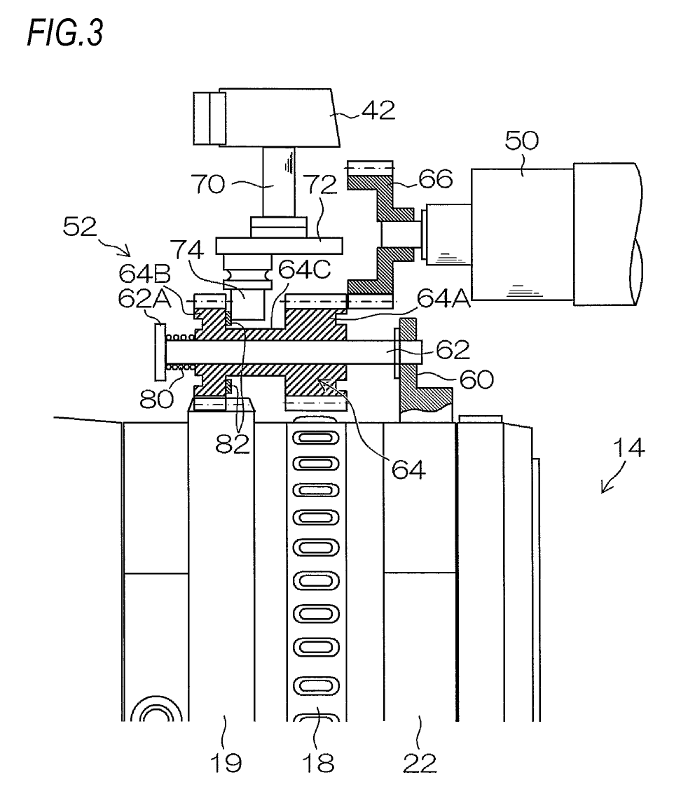

Next, the structure of the zoom drive mechanism of the driver 40 will be described by using the relevant part enlarged views of FIGS. 2 and 3. In these figures, a peripheral part of the zoom ring 18 of the lens barrel 14 where the zoom drive mechanism is set is shown in an enlarged state. In these figures, the detailed structure of the clutch mechanism 52 that activates and deactivates the coupling between the motor 50 and the zoom ring 18 is shown. In FIG. 2, the clutch mechanism 52 is in the servo driving state. In FIG. 3, the clutch mechanism 52 is in the manual driving state. The structure of the zoom drive mechanism will be described by using mainly FIG. 2. Elements in FIG. 3 are the same as those of FIG. 2 denoted by the same reference numerals.

In FIG. 2, a bearing member 60 is attached to a body part (stationary part) 22 of the lens barrel 14 adjacent to the zoom ring 18 which is rotatably disposed on the lens barrel 14. A shaft 62 parallel to the direction of the optical axis is fixed to the bearing member 60. A switching gear 64 is supported so as to be movable in the axial direction and rotatable with respect to the shaft 62.

The switching gear 64 is formed of a first gear 64A on the rear side, a second gear 64B on the front side and a concave portion 64C in the center. When the clutch mechanism 52 is in the servo driving state, the first gear 64A meshes with a gear 66 attached to the output shaft of the motor 50. On the other hand, the second gear 64B meshes with an external tooth 19 formed on the periphery of the zoom ring 18.

According to this, when the motor 50 is driven to rotate the gear 66, the switching gear 64 is rotated through the first gear 64A. When the switching gear 64 is rotated, the second gear 64B is rotated to thereby rotate the zoom ring 18 through the external tooth 19. Thus, the zoom ring 18 is in the state of being driven by the motor 50.

On the other hand, to the operation switching knob 42, a rotor plate 72 is attached through a decentered shaft 70 pivotally supported by a non-illustrated casing of the driver 40. To the rotor plate 72, a drive pin 74 is attached so that its axial position is different from that of the decentered shaft 70, and an end of the drive pin 74 is situated in a state of being inserted in the concave portion 64C of the switching gear 64.

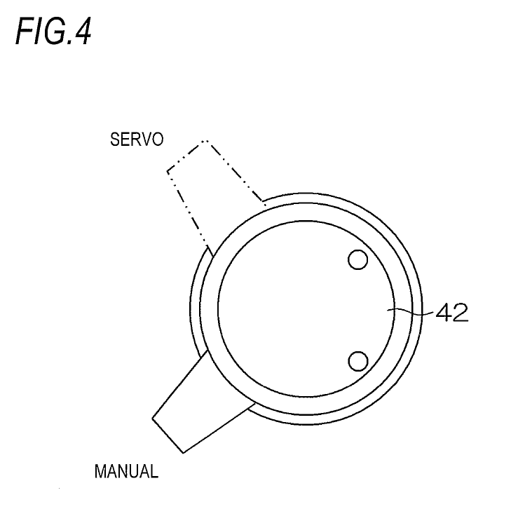

The operation switching knob 42 is rotated to switch between the position to select servo driving and the position to select manual driving as shown in FIG. 4. FIG. 2 shows a case where the operation switching knob 42 is set at the position to select servo driving and the clutch mechanism 52 is in the servo driving state.

On the contrary, when the operation switching knob 42 is switched from the position to select servo driving to the position to select manual driving, the clutch mechanism 52 is switched to the manual driving state. At this time, as shown in FIG. 3, the drive pin 74 is switched from the state of abutting against the first gear 64A (the side surface on the side of the first gear 64A) to the state of abutting against the second gear 64B (the side surface on the side of the second gear 64B) in the concave portion 64C of the switching gear 64, and the switching gear 64 moves to the position in the figure along the shaft 62. That is, by the pressing force of the drive pin 74 involved in the rotation of the operation switching knob 42, the switching gear 64 moves to a position where the first gear 64A does not mesh with the gear 66 of the motor 50 under a condition where the state in which the second gear 64B meshes with the external tooth 19 of the zoom ring 18 is maintained.

According to this, since the coupling between the motor 50 and the zoom ring 18 is deactivated (cut off), the zoom ring 18 can be rotated by the manual force of the hand grasping the zoom ring 18 without any load on the motor 50.

When the operation switching knob 42 is switched from the position to select manual driving to the position to select servo driving, the drive pin 74 is switched from the state of abutting against the second gear 64B to the state of abutting against the first gear 64A in the concave portion 64C of the switching gear 64, and the switching gear 64 moves to the position in FIG. 2 along the shaft 62. That is, the switching gear 64 moves to a position where the first gear 64A meshes with the gear 66 of the motor 50 and the second gear 64B meshes with the external tooth 19 of the zoom ring 18.

As shown in FIGS. 2 and 3, a flange 62A is provided on the front side of the shaft 62, and a spring (coil spring) 80 is disposed between the flange 62A and the side surface on the front side of the second gear 64B. Moreover, a friction member 82 is attached to the side surface on the side of the second gear 64B in the concave portion 64C of the switching gear 64.

The spring 80 is adjusted so that its length is substantially a natural length when the operation switching knob 42 is set at the position to select servo driving and the clutch mechanism 52 is in the servo driving state as in FIG. 2. Consequently, in the concave portion 64C of the switching gear 64, no high pressure is applied against the abutting surface between the drive pin 74 and the first gear 64A, and even when the motor 50 is driven to rotate the switching gear 64, no strong frictional force (frictional resistance) is caused on the abutting surface.

On the other hand, when the operation switching knob 42 is set at the position to select manual driving and the clutch mechanism 52 is in the manual driving state as in FIG. 3, the spring 80 is in a state of being largely compressed from the natural length. Consequently, a force acts that impels (presses) the switching gear 64 rearward, in the concave portion 64C of the switching gear 64, a pressure is applied against the abutting surface between the drive pin 74 and the second gear 64B, and when the switching gear 64 is rotated, a comparatively high frictional resistance is caused on the abutting surface.

Further, the friction member 82 for increasing the frictional resistance is attached to the abutting surface of the second gear 64B. Consequently, when the clutch mechanism 52 is in the manual driving state, a higher frictional resistance is caused with respect to the rotation of the zoom ring 18 (rotation of the switching gear 64).

According to this, when the zoom ring 18 (zoom lens) is manually driven and the lens barrel 14 is tilted upward or downward, applying an intentional load (frictional resistance) against the rotation of the zoom ring 18 prevents the zoom lens from moving (i) by the self weight of the zoom lens or (ii) by the self weight of the movable barrel for moving the zoom lens. Further, since operation is easier when a certain extent of load is applied also in manually rotating the zoom ring 18, an advantage is obtained also in operability. Since such a load is not applied when the zoom ring 18 is servo-driven, no excessive load is caused in servo driving, and the problem never occurs in that a faulty operation occurs or power consumption is increased.

While in the above-described embodiment, both the spring 80 and the friction member 82 are provided to cause a frictional resistance between the switching gear 64 and the drive pin 74, a structure where only one of them is provided may be adopted.

The friction member 82 may have a high frictional resistance, and one made of a material such as rubber or cork may be employed.

While in the above-described embodiment, the spring 80 is disposed on the front side of the second gear 64B of the switching gear 64, the following structure may be adopted: The spring 80 is disposed on the rear side of the first gear 64A of the switching gear 64 so that the length of the spring 80 is the natural length when the clutch mechanism 52 is in the servo driving state (the switching gear 64 is in the servo driving position) and the spring 80 is longer than the natural length (is in an extended state) when the clutch mechanism 52 is in the manual driving state (the switching gear 64 is in the manual driving position), and the spring 80 is caused to act as a tension spring in the manual driving state.

The mechanism for moving the switching gear 64 between the position of servo driving and the position of manual driving is not limited to the above-described embodiment. For example, a structure may be adopted in which the drive pin 74 is moved in the direction of the optical axis in conjunction with a slide switch.

While an embodiment is described in which the present invention is applied to a zoom drive mechanism for driving the zoom ring 18 of the lens barrel 14 by a motor or by hand, the present invention is also applicable, similarly to the above-described embodiment, to a drive mechanism for driving a given operation ring by a motor or by hand like a focus ring or an iris ring.

What is claimed is:

1. A lens barrel driver comprising:
an operation ring that is rotatably provided on a lens barrel;
a motor that drives the operation ring;
a power transmitting member that is rotatably supported by a stationary shaft, the power transmitting member being disposed so as to be movable between a position of a motor driving state and a position of a manual driving state;
a state switching member engaged with the power transmitting member, the state switching member moving the power transmitting member between the position of the motor driving state and the position of the manual driving state; and
a resistance applying unit that applies a resistance against a rotation of the power transmitting member at an abutting portion between the power transmitting member and the state switching member when the power transmitting member is set at the position of the manual driving state, the resistance applying unit applying a resistance against a rotation of the operation ring when the power transmitting member is set at the position of the manual driving state,
wherein the power transmitting member is coupled to both the operation ring and the motor when being at the position of the motor driving state,
the power transmitting member transmits a power of the motor to the operation ring when being at the position of the motor driving state, and
the power transmitting member is coupled to the operation ring and is separated from the motor at the position of the manual driving state.

2. The lens barrel driver according to claim 1,
wherein the resistance applying unit comprises a spring that presses the power transmitting member against the state switching member when the power transmitting member is set at the position of the manual driving state,
a length of the spring, when the power transmitting member is set at the position of the motor driving state, is substantially a natural length, and
the spring, when the power transmitting member is set at the position of the manual driving state, is extended or compressed so as to be longer or smaller than the natural length.

3. The lens barrel driver according to claim 1,
wherein the resistance applying unit comprises a friction member that is provided to cause a frictional resistance against the rotation of the power transmitting member at the abutting portion between the power transmitting member and the state switching member when the power transmitting member is set at the position of the manual driving state.

4. The lens barrel driver according to claim 2,
wherein the resistance applying unit further comprises a friction member that is provided to cause a frictional resistance against the rotation of the power transmitting member at the abutting portion between the power transmitting member and the state switching member when the power transmitting member is set at the position of the manual driving state.

5. The lens barrel drive according to claim 1, wherein
the resistance applying unit applies the resistance against the rotation of the power transmitting member at the abutting portion between the power transmitting member and the state switching member only when the power transmitting member is set at the position of the manual driving state.
